(19) United States
(12) Patent Application Publication
(10) Pub. No.: US 2010/0154514 A1
(43) Pub. Date: Jun. 24, 2010

(54) METHOD OF DETERMINING THE EVOLUTION OF PETROPHYSICAL PROPERTIES OF A ROCK DURING DIAGENESIS

(76) Inventors: Lionnel ALGIVE, Rueil-Malmaison (FR); Samir BEKRI, Rueil-Malmaison (FR); Olga VIZIKA, Rueil-Malmaison (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/634,861

(22) Filed: Dec. 10, 2009

(30) Foreign Application Priority Data
Dec. 18, 2008 (FR) 08/07273

(51) Int. Cl. G01N 15/08

(52) U.S. Cl. 73/38

(57) ABSTRACT

A method for quantitative determination of the permeability and porosity evolution of a porous medium during diagenesis having application to oil reservoir development is disclosed. A diagenesis scenario and an initial structure of the pore network of the porous medium are defined.

A representation of the pore network is constructed by a PNM model. The steps of the diagenesis scenario are determining the ion concentration on the pore and channel walls of the PNM model, for a precipitation or dissolution reaction according to the scenario, and deducing therefrom a geometry variation of the PNM model, the porosity is calculated geometrically and the permeability is calculated from Darcy's law for the modified PNM model; the foregoing steps are repeated according to the diagenesis scenario and a relationship is deduced between the permeability of the porous medium and the porosity of the porous medium during diagenesis.

### BACKGROUND OF THE INVENTION

1. Field of the Invention

The present invention relates to petroleum field exploration and production. The invention notably is a method for accounting for the evolution of petrophysical properties during diagenesis, for study of fluid flows within a heterogeneous formation. The method allows determination of the potential location of an underground reservoir within a sedimentary basin, or to enhance the recovery of hydrocarbons in a reservoir, or an underground reservoir.

2. Description of the Prior Art

Diagenesis designates all the physico-chemical mechanisms responsible for the conversion of sediments into sedimentary rocks. During diagenesis, part of the sediments is dissolved, and then transported. During transport, the change in the thermodynamic conditions causes ion precipitation leading to sediment cementation and to rock formation (lithification). These thermodynamic changes are either due to physical property variations (pressure, temperature), or to chemical composition changes (mixing with other dissolved minerals). The minerals can then be redissolved, then crystallized again. The alternation of these dissolution and precipitation cycles leads to the progressive evolution of the medium.

Diagenesis thus is a process converting a homogenous granular porous medium to a heterogeneous consolidated medium. The petrophysical properties of the resulting sedimentary rocks closely depend on the diagenetic cycle that modifies the initial porosities and permeabilities. The unequal development of diagenesis in time and in space is responsible for the heterogeneities observed at local scale as well as at the scale of the sedimentary basin.

Better comprehension of these phenomena allows extrapolation of more reliably the characteristics of the rocks from the samples that may have been taken and analyzed.

Applied to the petroleum field, this information leads to better field development while improving reservoir characterization. On the one hand, the reserves can be assessed more precisely if it is possible to estimate the porosity evolution due to diagenesis, which has a direct impact on the amount of potentially accumulated hydrocarbons. On the other hand, the production plan can be adjusted to the estimated permeabilities by best optimizing the extraction facilities. Thus, reconstruction of the diagenetic cycle is a means for better characterizing heterogeneities and it therefore constitutes an appreciable help when working out a production scenario.

The petroleum industry thus needs tools allowing petrophysical diagenesis modelling. It determines the evolution over time of the petrophysical properties of the rocks, in particular permeability and porosity, as a result of the dissolution-precipitation cycles of the diagenesis.

There is currently no method providing the evolution of permeabilities and porosities during diagenesis. However, for a facies, that is a rock type associated with a particular diagenetic history, geologists summarize their observations in empirical correlations. Such an approach is illustrated in the study by Lucia, F. Jerry, “Carbonate Reservoir Characterization”, Springer, (2007), EAN13: 9783540727408.

Petrophysicists have established models for relating permeability to porosity. One of the most famous ones is the Kozeny-Carman law (Carman P. C., Fluid flow through granular bed, Trans. Inst. Chem. Eng. Lond., 1937, 15, p. 150-166). However, these correlations are valid only at a given time, always for a given structure type (facies). Now, during diagenesis, the structure is modified and the porous medium can follow a different permeability-porosity relation. To date, it is not known how to quantify their respective modification.

Thus, the invention relates to a method of monitoring the evolution of the petrophysical properties of a porous medium during diagenesis. It is based on a pore-scale study, by modelling the pore network of the porous medium (rock) whose geometry varies during diagenesis.

### SUMMARY OF THE INVENTION

The invention relates to a method for quantitative determination of a permeability and porosity evolution of a porous medium during a diagenesis, the porous medium comprising a pore network. The method comprises:

defining a diagenesis cycle comprising cycles of precipitation and dissolution in the porous medium, as well as an initial pore network structure, by physical measurements and observations of the medium,
constructing a representation of the pore network by a Pore Network Model (PNM) comprising a set of nodes of known geometry connected by channels of known geometry; then, for each cycle of the diagenesis cycle, carrying out steps a) to d) below:
a). determining an ion concentration on the walls of each node and channel;
b). deducing therefrom a geometry variation for the nodes and channels of the PNMI;
c). determining a permeability and a porosity of the modified PNM model;
d). repeating a) to c) until completion occurs according to the diagenesis cycle; and
determining a relationship between permeability of the porous medium and the porosity of the porous medium during the diagenesis.

According to the invention, the representation of the pore network can be constructed by mercury invasion experiments on cores extracted from the porous medium. Other petrophysical properties, such as relative permeability and capillary pressure, can also be determined at the end of each cycle of the diagenesis cycle.

According to the invention, the porosity can be determined by volume calculations, knowing the geometry of the PNM, and the permeability can be determined using Darcy's law.

The invention also relates to a method of determining the potential location of an underground reservoir within a sedimentary basin making up a porous medium. According to method, a relationship is determined between the permeability of the porous medium and the porosity of the porous medium during diagenesis cycle undergone by the basin, by the method according to the invention. Fluid flows within the basin are then studied by means of a basin simulator informed by this relationship.

The invention furthermore relates to a method for enhancing hydrocarbon recovery in an underground reservoir making up a porous medium, wherein heterogeneities of the reservoir are determined by determining a relationship between the permeability and the porosity of the reservoir during diagenesis cycle undergone by the reservoir, by the method according to the invention, and fluid flows within the reservoir are studied by a reservoir simulator determined by the relationship.

### BRIEF DESCRIPTION OF THE DRAWINGS

Other features and advantages of the method according to the invention will be clear from reading the description hereafter of embodiments given by way of non limitative example, with reference to the accompanying figures wherein:

FIG. 1 shows stages of the method according to the invention for studying the diagenesis from a petrophysical point of view at pore scale;

FIG. 2 diagrammatically shows a unit cell of a “pore network” model with a cubic node (pore body) and six channels of triangular section (pore throats or thresholds);

FIG. 3 shows a diagenetic cycle in a homogeneous medium for which the intrinsic dissolution rate is equal to the precipitation rate;

FIG. 4 illustrates a diagenetic cycle in a homogeneous medium for which the intrinsic dissolution rate is 100 times lower than the precipitation rate;

FIG. 5 shows a diagenetic cycle in a heterogeneous medium for which the intrinsic dissolution rate is 100 times lower than the precipitation rate. The presence of heterogeneity inverts the overall permeability evolution direction;

FIG. 6 shows the solute concentration field observed in the network for the diagenetic cycle of FIG. 5 during precipitation. The high concentrations (in black) are generally present in the larger pores, which explains the more marked porosity drop in FIG. 5 in relation to FIG. 4; and

FIG. 7 illustrates, for the diagenetic cycle of FIG. 5, the translation of the pore size distribution during dissolution. It is a simple translation due to the slowness of the reaction in relation to the diffusive transport, which allows the solute concentration to be homogenized.

### DETAILED DESCRIPTION OF THE INVENTION

The invention relates to a method of determining the evolution of the petrophysical properties of rocks during diagenesis. This information can be used by a basin simulator and/or a reservoir simulator within the field of petroleum exploration and production.

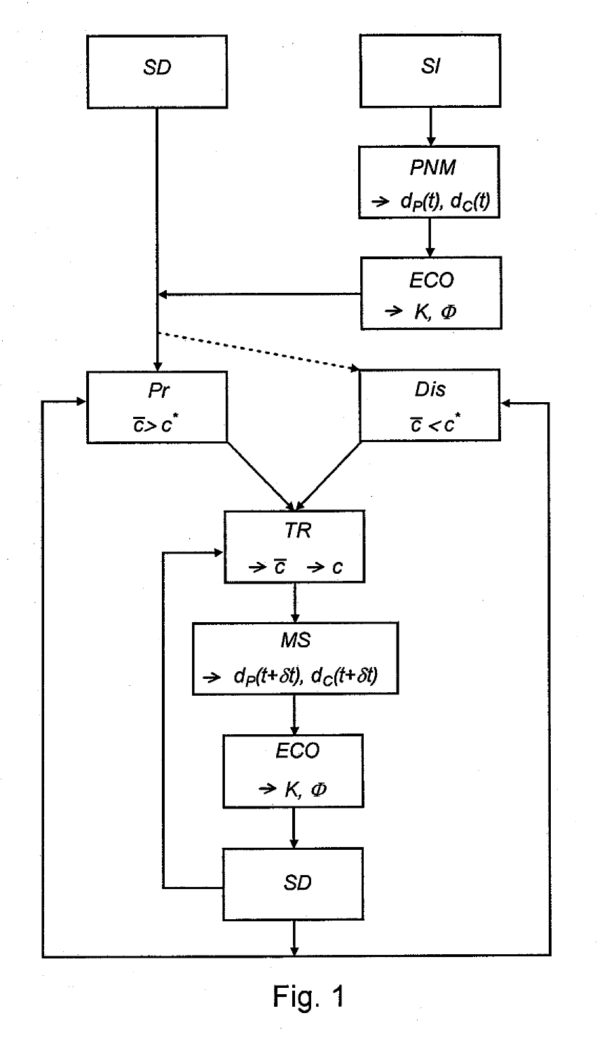

FIG. 1 illustrates the various stages of this method that comprises:

A. Determining a diagenesis cycle (SD)
B. Determining the evolution of the petrophysical properties during diagenesis

1. Constructing a Porous Network Model (PNM)

2. Determining the porosity and permeability evolution
2a. Determining the initial porosity (Φ) and permeability (K): ECO
2b. Determining the overall ( c̅) and local (c) concentrations: TR
2c. Determining structure modifications of the porous network: MS
2d. Determining the porosity and the permeability after the reaction: ECO.

By following the diagenesis cycle defined in A, 2a to 2d are successively carried out for a precipitation reaction (Pr), then for a dissolution reaction (Dis), as illustrated in FIG. 1.

A. Determining a Diagenesis Scenario

The date of formation of a sedimentary basin is determined from field studies (geological, geophysical, petrophysical studies): 10 million years ago for example. By analogy with the present, the basis of the geological science that supposes that the same causes lead to the same effects, it is possible to define the structure of this porous medium. One then speaks of an initial structure (SI). This medium thereafter undergoes the effects of the diagenesis and is converted to a rock. To evaluate these effects, a diagenesis cycle has to be defined. It defines the chronology of the alternations of precipitation and dissolution cycles. For example, it is considered that the rock has undergone, for the first 200,000 years that followed its setting, precipitations, then dissolutions for a million years, then again precipitations for two million years, then . . .

At this stage, this diagenetic cycle allows prediction of the evolution of the petrophysical properties during diagenesis only qualitatively, that is permeability or porosity rise or drop. Quantification of these evolutions is the subject of point B.

B. Determining the Evolution of the Petrophysical Properties During Diagenesis

1. Constructing a Pore Network Model

According to the invention, the diagenesis cycle, that is ion transport, dissolution and precipitation phenomena, are modelled at pore scale. A simplified spatial representation of the pore network formed by the pores of the rock is therefore used.

A well-known representation type, referred to as “Pore Network Modelling” (PNM), is therefore used. A detailed description of this PNM technique in terms of approach, model characteristics and construction is presented in the following document:
Laroche, C. and Vizika, O., “Two-Phase Flow Properties Prediction from Small-Scale Data using Pore-Network Modeling”, Transport in Porous Media, (2005), 61, 1, 77-91.

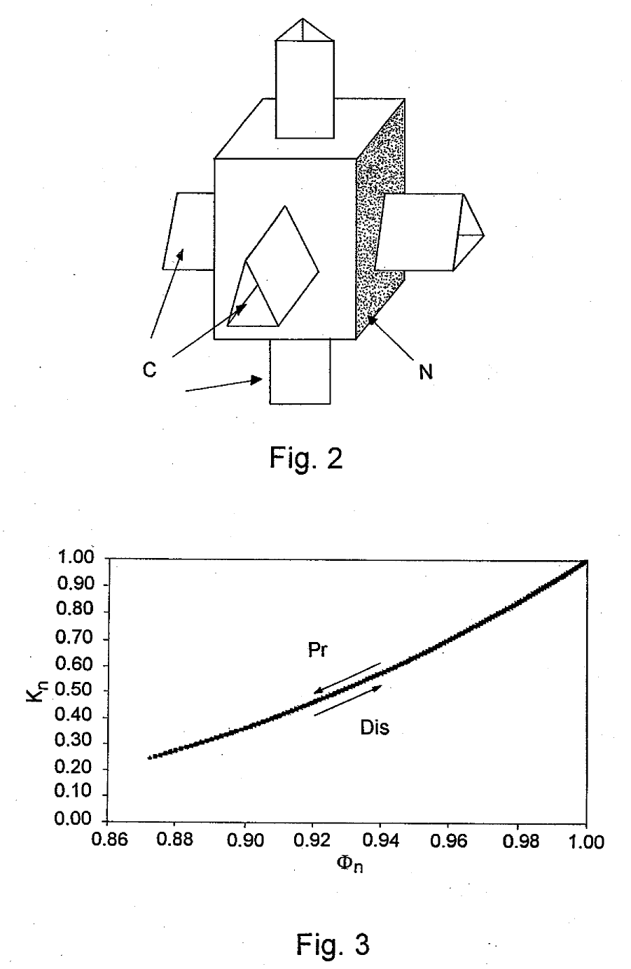

This PNM is a conceptual representation of a porous medium whose goal is to account for the flow and transport phenomena physics, without taking the real structure of the network formed by the pores of the porous medium (rock) into consideration. The structure is modelled by a three-dimensional pore network making up the nodes, interconnected by channels, representing the links between the pores. Although it does not describe the exact morphology of the porous medium, such a model can take into account the essential topology and morphology characteristics of the porous space. A real porous medium comprises angulosities and recesses that favour the flow of the wetting fluid, even when the center of the channel or of the pore is filled by a non-wetting fluid. To account for this fact, which influences the recovery, angular sections are preferably considered for the pores and the channels. The pore network is therefore represented by a three-dimensional cubic matrix of pores interconnected by channels and having generally a coordination number of six (but it can be variable), which means that 6 channels are connected to each pore. As illustrated in FIG. 2, a node (N) and its channels (C) are referred to as unit cell, or cell, of the network model.

To construct such a model, it is necessary to carry out mercury invasion experiments (mercury porosimetry) in the laboratory. This known technique, allows determination of the size distributions of the thresholds represented by the channels in the network model (PNM).

The size distribution of the pores is determined from this distribution. A correlation is therefore considered between the pores and their adjacent channels. An aspect ratio (AR) relating the pore diameter dₚ to the channel diameter d_{c} is then established. During construction of the network, the channel diameters are randomly assigned in accordance with the experimental distribution obtained by mercury porosimetry. It can be noted that, in the case of a triangular section, the diameter corresponds to that of the circle inscribed in the triangle being considered.

2. Determining the Porosity and Permeability Evolution

The PNM then allows describing the effects of a reactive flow on the transport properties and on the structure evolution.

A numerical approach is used to simulate the evolution of the petrophysical properties caused by the alternation of dissolutions and precipitations. From a petrophysical point of view, study of the diagenesis is structured around two tasks: solution of the reactive transport, which determines the concentration field in the pore network, and calculation of the structure changes potentially caused by the reactions.

These two aspects of the diagenesis are solved separately: the method according to the invention is a method referred to as “step by step”: the transport part (including flow) is solved on a constant geometry basis and the pore structure modifications are determined with constant concentrations.

2a. Determining the Initial Porosity and Permeability

The porosity of the pore network, corresponding to the core-scale porosity, can then be determined. In fact, the porosity is defined as the ratio of the void volume to the total volume. The total volume of the pore network is known (Lx*Ly*Lz, product of the lengths of the pore network in each direction), and the void volume corresponds to the volumes of the pores and to the volumes of the channels. These volumes are obtained by simple geometrical calculations (volume of a cylinder, of a sphere, . . . ).

Flow determination is a preliminary condition for any transport study in the presence of convection. It consists, for a given initial rock structure, determines the pressure field. For each channel of a unit cell of the PNM, the conductances are calculated from the known Poiseuille solution for a laminar flow. These conductances linearly connect the flow rate and the pressure difference between two adjacent nodes.

Qᵢⱼ=gᵢⱼ(Pᵢ−Pⱼ)

where:

Qᵢⱼ is the flow rate between pores i and j.

gᵢⱼ is the hydraulic conductance of the channel between nodes i and j.

Pᵢ and Pⱼ are respectively the pressures of node i and of node j.

The conservation of the flow rates at the nodes is then written. Thus n equations are obtained with seven unknowns each, if a network of n pores is assumed having a coordination number equal to 6.

$${\sum }_{j = 1}^{6} {Q}_{ij} = {\sum }_{j = 1}^{6} {g}_{ij} ( {P}_{i} - {P}_{j} ) = 0$$

This linear system can be synthesized in the following matricial form:

Ax=b

where:

A is the matrix containing the conductances

x is the unknown vector of the n pressures

b is the second member vector containing the boundary conditions.

The n unknown pressures are then determined by a conventional solution methods such as, for example, the biconjugate gradient method.

Knowing the pressures, it is possible to calculate, by means of the conductances, the flow rates, then the velocities in each channel.

At network scale, the permeability relating the total flow rate to the pressure gradient is deduced from Darcy's equation.

A detailed description of these permeability and porosity determination techniques is given in the following document: Laroche, C. and Vizika, O., “Two-Phase Flow Properties Prediction from Small-Scale Data Using Pore-network Modeling”, Transport in Porous Media, (2005), 61, 1, 77-91.

2b. Determining the Ion Concentrations

Solution of the reactive transport solves, over the entire PNM, the macroscopic convection-dispersion equation for a reactive solute in the presence of a reaction (precipitation, dissolution). Assuming a linear kinetic law (but the methodology can be applied to more complex reactions), this equation is written as follows:

$$\frac{\partial \overline{c}}{\partial t} + ∇ \cdot ( {\overline{v} }^{*} \overline{c} - {\overline{D}}^{*} ∇ \overline{c} ) + {\overline{γ}}^{*} ( \overline{c} - {c}^{*} ) = 0$$

where:

c̅ is the mean concentration of a unit cell of the network

c* is the equilibrium concentration

y̅* is the apparent reactive coefficient derived from volume and/or surface reactions

v̅* is the mean velocity of the solute, different from the mean velocity of the fluid

D̅* is the dispersion coefficient, or dispersion tensor of the solute (not reduced to the Taylor-Aris dispersion).

Coefficients y̅*, v̅* and D̅* are referred to as macroscopic coefficients. These coefficients are analytically calculated for each unit cell of the network, by solving the microscopic equations and by performing a scale change. It is then possible to determine the deposition maps, and to deduce therefrom their impact on the petrophysical properties.

Concentration field c̅ is the unknown vector of the system to be solved by integrating the conservation equation at the node (mass balance). These balances involve the matter fluxes (ions) between the pores, which can be expressed as a function of the mean concentrations at the nodes and of the macroscopic transport coefficients.

The first stage calculates the previous macroscopic coefficients for each unit cell of the network. It is thus possible to use the analytical method of moments and to solve the associated eigenvalue problem. This technique is described for example in the following document:
Shapiro M., Brenner H., Dispersion of a Chemically Reactive Solute in a Spatially Model of a Porous Medium, Chemical Engineering Science, 1988, 43, p. 551-571.

This theory is based on the integration, on a medium assumed to be infinite or periodic, of the previous macroscopic equation weighted by the positions. In other words, the spatial moments are calculated. These moments are compared with those calculated from the system of local equations, presented hereafter, allowing calculation of the local concentration c, that is the concentration within a pore or a channel as a function of its distance to the centre. This system of equations has an analytical solution for elementary geometries, such as those used in the construction of the PNM model. The technique described in the following document can for example be used for analytically solving this system:
Bekri S., Thovert J.-F., Adler P. M., “Dissolution of Porous Media”, Chem. Eng. Sci., (1995) 50, 17, p. 2765-2791.

By identification, it is then possible to express the macroscopic coefficients by the local parameters (kinetic constant on the wall, local velocities of the fluid, molecular diffusion, . . . ).

$$\{ \begin{matrix}\frac{\partial c}{\partial t} + ∇ \cdot ( vc - D ∇ c ) = 0 \\ ( vc - D ∇ c ) \cdot n = κ c sur {S}_{p}\end{matrix}$$

where:

D is the molecular diffusion coefficient,

n is the normal to the wall pointing towards the solid,

K is the reaction velocity constant, and

Sₚ is the surface of the wall.

During the second stage, knowing these coefficients explicitly, the partial derivative equation of the macroscopic transport, which amounts to an ordinary differential equation in asymptotic regime, is solved analytically in a channel. After determining the mean concentrations along the axis of the channel, the matter fluxes entering each pore are deduced. This calculation allows estimation of the fluxes with a precision unparalleled by ordinary numerical approximations, of air upstream scheme type for convection and of linear approximation type for diffusion.

Finally, during the third stage, the system of equations is written in matricial form. The matrix equation is then solved by inversion so as to obtain the concentration field. The network-scale (core) concentration field is thus obtained from a calculation of the ion fluxes at pore scale.

2c. Determining Structure Modifications of the Pore Network

The structural modifications of the pore network correspond to a change in the diameter of the pores and/or channels as a result of the precipitation and dissolution reactions.

The mean ion concentrations and the wall concentration (c at Sₚ) are determined in stage 2b. After experimentally measuring the intrinsic kinetics κ of the reaction studied, calcite dissolution for example, the reactive flux density φᵢ of ions emitted or consumed is calculated from this concentration at the interface.

φᵢ=κ(c−c*)

Knowing the reaction stoichiometry, the molar mass and the density of the mineral formed, these fluxes are connected to an infinitesimal layer of mineral created or removed, therefore to a relative growth rate of the pore. Of course, this layer is not necessarily uniform. Its distribution in the network depends on the reaction and flow regimes.

$$\begin{matrix}{ϕ}_{m} = {αϕ}_{t} \\ \frac{\partial d}{\partial t} = \frac{M}{ρ} {ϕ}_{m}\end{matrix} \} ⇒ d ( t + δ t ) = d ( t ) + δ t \cdot α \frac{M}{ρ} κ ( c - {c}^{*} )$$

where:

α is the stoichiometric coefficient

φₘ is the mineral flux density in mol·m⁻²·s⁻¹

M and ρ are the molar mass and the density of the mineral respectively

d represents the diameter of a pore or of a channel. Thus, d(t) is the diameter of a pore or of a channel at the time t, and d(t+δt) corresponds to the diameter of this pore or of this channel at the time t+δt.

The deformation time δt to be applied is optimized according to the desired precision as regards the intensity of the permeability and porosity variations.

2d. Determining the Porosity and the Permeability after the Reaction

After each deformation stage (stage 2c), the petrophysical properties are recalculated as in stage 2a.

By following the diagenesis cycle (SD) defined in stage A, stages 2a to 2d are successively carried out for a precipitation reaction, then for a dissolution reaction, as illustrated in FIGS. 1 and 3.

In addition to the interest of observing the diagenesis at pore scale by drawing up deposition maps of the network, the method makes it possible to store, after each structural modification, the new porosities and permeabilities in order to obtain different correlations. The permeability and porosity evolution can be used by a basin simulator and/or a reservoir simulator within the context of petroleum exploration and production. These correlations are integrated in the reservoir or basin simulators as input data upon reconstruction of the geological history of the field.

In the petroleum field, knowing the diagenetic cycle can lead to a better field development as a result of a better characterization, past and present, of the reservoir. On the one hand, the reserves can be assessed more precisely by estimating the porosity evolution due to diagenesis, which has a direct impact on the amount of potentially accumulated hydrocarbons. On the other hand, the reservoir production plan can be adjusted to the estimated permeabilities by best optimizing the extraction facilities. Thus, reconstruction of the diagenetic cycle is a way of better characterizing heterogeneities and it therefore constitutes an appreciable help when working out the production scenario.

The method thus allows determination of the potential location of underground reservoirs within a sedimentary basin (using a basin simulator) or to enhance the recovery of hydrocarbons in a reservoir or an underground reservoir (using a reservoir simulator).

Applications

The method according to the invention is applied hereafter to three different examples, extremely simplified. These examples allow illustration of the ability of the method to describe and interpret the consequences of diagenesis on petrophysical properties.

In the examples hereafter, the permeabilities and the porosities are normalized by their initial value, that is their value prior to diagenesis. The normalized permeabilities are denoted by Kₙ and the normalized porosities are denoted by φₙ. Furthermore, in each example, one a diagenesis cycle is selected comprising, twice, a precipitation stage followed by a dissolution stage, whose lengths are arbitrarily set. In reality, the length has to coincide with the diagenetic cycle established by the geologist. It is considered that there is no exterior matter supply and that, at the end of the dissolution period, all of the previously precipitated solute has been dissolved. Consequently, at the end of the cycle, the porosity is equal to the initial porosity (assuming that the crystals formed or removed have the same specific volume). However, this does not mean that the initial pore size distribution is obtained again, hence the probable permeability change. In fact, the permeability is linked with the diameter of the restrictions (channels) between the pores. Now, depending on the regime, dissolved matter may precipitate again, preferably either in the thresholds (channels) or in the pores, which leads to a permeability drop or rise respectively.

The diagenetic cycles observed are different according to the hydrodynamic and reaction regimes. Therefore, in order to be able to compare the experiments, the dimensionless numbers that govern the known reactive transport are succinctly introduced, that is:

the Péclet number, denoted by Pe, which compares the convective fluxes with the diffusive fluxes; and

the Péclet-Damköhler number, denoted by PeDa, which compares the reaction velocity with the velocity of transport of the solute to the wall.

For each example, the method is applied in order to determine the evolution of the porosity (φₙ) and of the permeability (Kₙ) during the diagenesis.

### Example 1

### Homogeneous Initial Geometry (all the Pores have the Same Diameter)

According to this example, a three-dimensional homogeneous network of 250 pores (10*5*5) is considered. The precipitation and dissolution reaction regimes are the same: Pe=10, PeDa=0.1 for the precipitations and the dissolutions.

In this instance, there is no permeability evolution. The initial and final porosity and permeability conditions are the same. The dissolution (Dis) and the precipitation (Pr) must have a different reaction regime to be able to eventually observe a permeability evolution. Otherwise, the effects of the other are cancelled, as illustrated in FIG. 3. FIG. 3 shows permeability (Kₙ) versus porosity (φₙ) for a simulated diagenetic cycle in a three-dimensional homogeneous network of 250 pores (10*5*5), with Pe=10, PeDa=0.1 for the precipitations and the dissolutions.

### Example 2

### Homogeneous Initial Geometry (all the Pores have the Same Diameter)

According to this example, a three-dimensional homogeneous network of 250 pores (10*5*5) is considered. This time, however, the precipitation and dissolution reaction regimes are different: PeDa=0.01 for dissolutions and PeDa=1 for precipitations. This corresponds to a dissolution that is one hundred times slower than the precipitation.

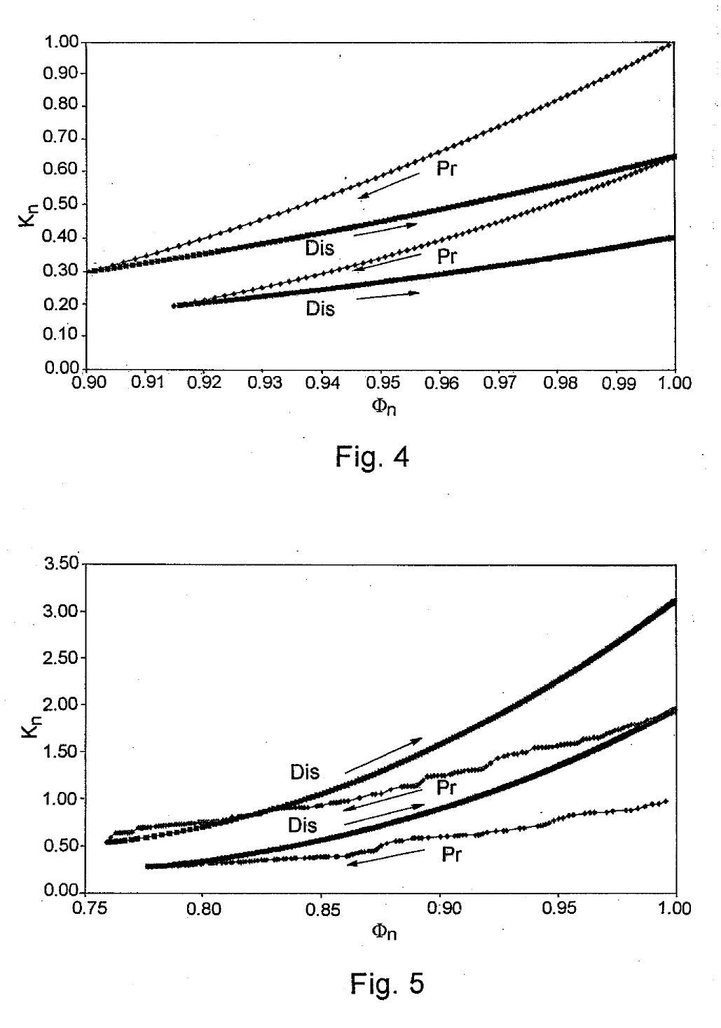

The method gives the evolution of the network-scale calculated permeability and porosity. FIG. 4 shows permeability (Kₙ) versus porosity (φₙ) for the diagenetic cycle in the three-dimensional homogeneous network of 250 pores (10*5*5). A marked permeability drop is observed during the diagenesis. This is explained by the enlargement of the pores and the reduction of the channels.

Since precipitation and dissolution do not cause the same deformation, because of different reactive regimes, the diagenetic cycle leads to an accentuation of the heterogeneity between pores and channels.

### Example 3

### Heterogeneous Initial Geometry (all the Pores do not have the Same Geometry)

One advantage of the method according to the invention is readily taking into consideration the effect of the pore network structure. To illustrate this capacity, diagenesis is simulated in a more realistic pore network with a pore size distribution.

According to this example, mean reactive regimes identical to the previous cases are selected: Pe=10, PeDa=1 for precipitation and PeDa=0.01 for dissolution. The heterogeneous character of the diameters generates a heterogeneity within the reaction regime.

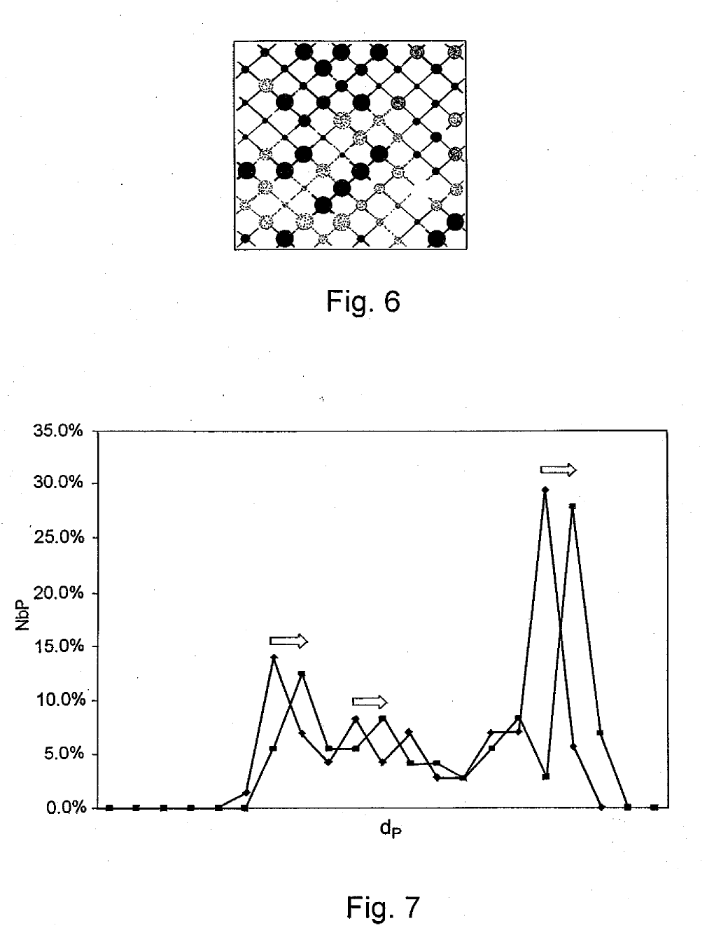

By applying the method according to the invention, it is established that there are nearly two orders of magnitude between the apparent reactive coefficient of the larger pores and that of the smaller ones. This decrease in the apparent reactive coefficient of the larger pores is translated into an accumulation of the solute in these volumes, which can be readily checked on a concentration map (FIG. 6, where the high concentrations are shown in black, the circles represent the pores and the lines connecting the pores represent channels). Consequently, the precipitation, which is proportional to the chemical unbalance, will be stronger in these pores and, to a lesser extent, along the paths connecting them. This is translated into a more marked porosity drop at the end of the first precipitation periods (compare FIGS. 4 and 5). The dissolution remains substantially uniform. It is possible to readily check this assertion from the method by plotting the pore size distribution. In this case, it is practically translated towards the larger pores, as illustrated in FIG. 7, where the curve with the diamonds represents the number of pores (NbP) versus diameter dᵢₚ of the pores before the reaction, and the curve with the squares represents the number of pores (NbP) versus diameter dₚ of the pores after the reaction.

On the other hand, the modification of the precipitation part entirely disrupts the course of the diagenetic cycle (FIG. 5). In fact, the matter dissolved in the restrictions settles in the pores, which leads to a very significant permeability increase. It is thus possible to explain, with the method according to the invention, how a totally different diagenetic cycle can be observed despite identical mean dimensionless numbers.

In summary, these experiments show that, for the reactive regime that is selected, in the case where the initial structure is homogeneous, a permeability decrease occurs, whereas for a certain heterogeneous distribution, the same regime leads to a permeability increase. In other words, small initial perturbations within the medium are likely to cause marked heterogeneities during diagenesis. On the other hand, if the reaction is very slow, precipitation and dissolution become reversible and the curves merge as in FIG. 3.

The method according to the invention thus is an efficient and simple tool for:

physically modelling transport, dissolution and precipitation phenomena at pore scale;

interpreting the mechanisms by means of hydrodynamic and reaction regimes, as well as the structural properties of the medium;

providing relationships allowing a scale change between the pore and the core then, using the correlations obtained in existing reservoir simulators, between the core and the reservoir.

The method furthermore allows carrying out a sensitivity study on some key parameters such as the pore size distribution or the aspect ratio, thus allowing study of various diagenesis cycles.

Finally, the method has been described within the context of permeability and porosity determination of a porous medium. However, by updating the structure of the pore network model, the invention applies to any petrophysical properties such as capillary pressure and relative permeabilities.

1-7. (canceled)

8. A method for quantitative determination of a permeability and porosity evolution of a porous medium during diagenesis, the porous medium including a pore network, the method comprising:
defining a diagenesis cycle comprising precipitations and dissolutions in the porous medium and an initial pore network structure by physical measurements and observations of the porous medium;
constructing a representation of the pore network by a Pore Network Model (PNM) comprising a set of nodes of known geometry connected by channels of known geometry;
for each stage of the diagenesis cycle, carrying out steps a) to d) comprising:
a) determining an ion concentration on walls of each node and channel;
b) deducing therefrom a geometry variation for the nodes and channels of the PNM;
c) determining a permeability and a porosity of the modified PNM; and
d) repeating a) to c) until diagenesis is completed according to the diagenesis cycle; and
determining a relationship between the permeability of the porous medium and the porosity of the porous medium during the diagenesis.

9. A method as claimed in claim 8, wherein the pore network representation is constructed by mercury invasion experiments on cores extracted from the porous medium.

10. A method as claimed in claim 8, wherein other petrophysical properties including capillary pressure and relative permeabilities are also determined at an end of each precipitation and dissolution of the diagenesis cycle.

11. A method as claimed in claim 9, wherein other petrophysical properties including capillary pressure and relative permeabilities also determined at the end of each precipitation and dissolution of the diagenesis cycle.

12. A method as claimed in claim 8, wherein the porosity is determined by volume calculations based upon knowing a geometry of the PNM.

13. A method as claimed in claim 9, wherein the porosity is determined by volume calculations based upon knowing a geometry of the PNM.

14. A method as claimed in claim 10, wherein the porosity is determined by volume calculations based upon knowing a geometry of the PNM.

15. A method as claimed in claim 11, wherein the porosity is determined by volume calculations based upon knowing a geometry of the PNM.

16. A method as claimed in claim 8, wherein the permeability is determined according to Darcy's law.

17. A method as claimed in claim 9, wherein the permeability is determined according to Darcy's law.

18. A method as claimed in claim 10, wherein the permeability is determined according to Darcy's law.

19. A method as claimed in claim 11, wherein the permeability is determined according to Darcy's law.

20. A method as claimed in claim 12, wherein the permeability is determined according to Darcy's law.

21. A method as claimed in claim 13, wherein the permeability is determined according to Darcy's law.

22. A method as claimed in claim 14 wherein the permeability is determined according to Darcy's law.

23. A method as claimed in claim 15, wherein the permeability is determined according to Darcy's law.

24. A method of determining a potential location of an underground reservoir within a sedimentary basin including a porous medium, wherein a relationship is determined between permeability of a porous medium and a porosity of the porous medium during diagenesis undergone by the basin, comprising:
defining a diagenesis cycle comprising precipitations and dissolutions in the porous medium and an initial pore network structure by physical measurements and observations of the porous medium;
constructing a representation of the pore network by a Pore Network Model (PNM) comprising nodes of known geometry connected by channels of known geometry;
for each cycle of the diagenesis cycle, carrying out steps a) to d) comprising:
a) determining an ion concentration on walls of each node and channel;
b) deducing therefrom a geometry variation for the nodes and channels of the PNM;
c) determining a permeability and a porosity of the modified PNM; and
d) repeating a) to c) until diagenesis is completed according to the diagenesis cycle;
determining the relationship between the permeability of the porous medium and the porosity of the porous medium during the diagenesis; and
studying fluid flows within the basin using a basin simulator based upon the relationship.

25. A method for enhancing hydrocarbon recovery in an underground reservoir including a porous medium, wherein heterogeneities of the reservoir are determined by determining a relationship between permeability and porosity of the reservoir during diagenesis undergone by the reservoir comprising:
defining a diagenesis cycle comprising precipitations and dissolutions in the porous medium and an initial pore network structure by physical measurements and observations of the porous medium;
constructing a representation of the pore network by a PNM model comprising nodes of known geometry connected by channels of known geometry;
for each cycle of the diagenesis cycle, carrying out steps a) to d) comprising:
a) determining an ion concentration on walls of each node and channel;
b) deducing therefrom a geometry variation for the nodes and channels of the PNM;
c) determining a permeability and a porosity of the modified PNM model; and
d) repeating a) to c) until diagenesis is completed according to the diagenesis cycle; and
determining the relationship between the permeability of the porous medium and the porosity of the porous medium during the diagenesis; and
studying fluid flows within the reservoir using a reservoir simulator based upon the relationship.
